(19) United States
(12) Patent Application Publication
(10) Pub. No.: US 2022/0371597 A1
(43) Pub. Date: Nov. 24, 2022

(54) DRIVING SUPPORT SYSTEM

(71) Applicant: FURUKAWA ELECTRIC CO., LTD., Tokyo (JP)

(72) Inventors: Hirokazu NARUI, San Jose, CA (US); Kazuhiro FUNAKOSHI, San Jose, CA (US); Noriyuki YOKOUCHI, San Jose, CA (US); Jun MIURA, Tokyo (JP)

(73) Assignee: FURUKAWA ELECTRIC CO., LTD., Tokyo (JP)

(21) Appl. No.: 17/770,234

(22) PCT Filed: Oct. 2, 2020
(86) PCT No.: PCT/JP2020/037511

§ 371 Date: Apr. 19, 2022

Related U.S. Application Data
(60) Provisional application No. 62/927,868, filed on Oct. 30, 2019.

(51) Int. Cl. B60W 40/04; B60W 50/14; B60W 60/00; H04W 4/44

(52) U.S. Cl. CPC B60W 40/04; B60W 50/14; B60W 60/001; H04W 4/44; B60W 2554/4041; B60W 2556/45

(57) ABSTRACT

A driving support system uses information related to objects acquired by a sensor disposed external to a subject vehicle and position information of the subject vehicle to calculate information related to objects in a periphery of the subject vehicle, and provides a warning, position information or distance information to an autonomous driving control unit or a driver of the subject vehicle. A road side information processing unit or a vehicle control unit calculates vehicle periphery information related to objects in the periphery of the subject vehicle, using the information related to objects acquired from the sensor and the position of the subject vehicle detected by the first position detection unit.

### TECHNICAL FIELD

The present disclosure relates to a driving support system.

### BACKGROUND ART

In recent years, as a support system for an autonomous vehicle, a system has been presented which provides the information required in autonomous driving from roads and parking lots via road-vehicle communication or vehicle-vehicle communication such as that represented in Patent Documents 1 and 2.

Patent Document 1 discloses a system which specifies the position of a vehicle by way of road side sensors, for a vehicle to which a GPS receiver is not built in, and provides information according to the position of this vehicle. In addition, Patent Document 1 also discloses providing information outside the range which can be measured by the sensors of the vehicle from the road side, by employing the information of other vehicles.

Patent Document 2 discloses a system which provides, to the vehicle, information combining the latest information in a parking lot and vehicle distance measurement data in an environment which dynamically changes such as a parking lot so as to support autonomous driving.

### PRIOR ART DOCUMENTS

### Patent Documents

Patent Document 1: Japanese Unexamined Patent Application, Publication No. 2016-143092
Patent Document 2: Japanese Unexamined Patent Application, Publication No. 2019-109855

### SUMMARY OF THE INVENTION

### Problems to be Solved by the Invention

However, with the techniques proposed above, the vehicle cannot perform autonomous drive in the case of the sensors not being built in. Furthermore, in the case of sensors being built into the vehicle, since there can be a restriction in the height direction of the mounting position, tall vehicles such as trucks are obstacles, and thus it is not possible to penetrate these obstacles and detect obstacles which are farther away. In addition, in the case of mounting a plurality of sensors to a single vehicle, for example, sensors of a relatively large size, such as laser radars, may harm the external appearance of the vehicle.

The present disclosure takes account of the above situation, and has an object of providing a driving support system capable of providing information related to objects suited to autonomous driving of a vehicle, even in a case of having only a simple sensor or having no sensors on the vehicle.

The present invention has an object of providing a driving support system which can acquire information required for travel while suppressing an increase in cost.

### Means for Solving the Problems

(1) In a driving support system that uses information related to objects acquired by a sensor disposed external to a subject vehicle, and position information of the subject vehicle to calculate information related to objects in a periphery of the subject vehicle, and provides a warning, position information or information related to objects to an autonomous driving control unit or a driver of the subject vehicle, the driving support system includes: a road side information processing unit disposed at a road side; a vehicle control unit disposed on a side of the subject vehicle; and a first position detection unit that is disposed on the side of the subject vehicle or the road side and that detects a position of the subject vehicle, wherein the road side information processing unit or the vehicle control unit calculates vehicle periphery information related to objects in the periphery of the subject vehicle using the information related to objects acquired from the sensor, and the position of the subject vehicle detected by the first position detection unit, and wherein the road side information processing unit sends at least one of the information related to objects and the vehicle periphery information to the subject vehicle.

(2) The driving support system as described in (1) includes a road side communication unit disposed at the road side; and a vehicle communication unit disposed on the side of the subject vehicle, wherein the road side communication unit sends the vehicle periphery information to the vehicle communication unit.

(3) The driving support system as described in (1) further includes a road side communication unit which is disposed at the road side; and a vehicle communication unit disposed on the side of the subject vehicle, wherein the road side communication unit sends information related to objects acquired from the sensor to the vehicle communication unit, and wherein the vehicle control unit calculates the vehicle periphery information, using the information related to objects received from the vehicle communication unit and the position of the subject vehicle detected by the first position detection unit.

(4) In the driving support system as described in (1), the road side information processing unit or the vehicle control unit calculates the vehicle periphery information by performing coordinate conversion on the information related to objects acquired from the sensor relative to the position of the subject vehicle.

(5) In the driving support system as described in (1), the road side information processing unit or the vehicle control unit creates a space model from the information related to objects acquired from the sensor, and calculates the vehicle periphery information from the space model and the position of the subject vehicle.

(6) In the driving support system as described in any one of (1) to (5), the first position detection unit is disposed on the side of the subject vehicle, and detects the position of the subject vehicle using a positioning system that measures positions using a signal from a satellite.

(7) In the driving support system as described in any one of (1) to (5), the first position detection unit estimates the position of the subject vehicle using the information related to objects acquired from the sensor.

(8) In the driving support system as described in any one of (1) to (7), the position of the subject vehicle is an absolute position or a relative position.

(9) The driving support system as described in any one of (1) to (8) further includes the sensor mounted in a vehicle, wherein an integration unit that integrates information related to objects acquired from a plurality of the sensors is disposed on the road side, and the vehicle periphery information is calculated using the information related to objects integrated by the integration unit and the position of the subject vehicle detected by the first position detection unit.

(10) The driving support system as described in any one of (1) to (8) further includes the sensor disposed in at least one vehicle and on the road side, wherein an integration unit that integrates information related to objects acquired from a plurality of the sensors is disposed at the road side, and the vehicle periphery information is calculated using information related to objects integrated by the integration unit, and the position of the subject vehicle detected by the first position detection unit.

(11) In the driving support system as described in (10), the information related to objects acquired from the sensor disposed at the road side differs from the information related to objects acquired from the sensor disposed in the at least one vehicle.

(12) In the driving support system as described in any one of (9) to (11), the subject vehicle is included in the vehicle.

(13) In the driving support system as described in any one of (9) to (12), the vehicle in which the sensor is disposed includes a first setting unit that specifies whether or not to provide information related to objects acquired from the sensor to the integration unit.

(14) In the driving support system as described in any one of (1) to (8), at least two of the sensors, and an integration unit that integrates information related to objects acquired from the sensors are disposed at the roadside, and the vehicle periphery information is calculated using the information related to objects integrated by the integration unit and the position of the subject vehicle detected by the first position detection unit.

(15) In the driving support system as described in any one of (1) to (14), the subject vehicle includes a second setting unit that specifies whether or not to receive provision of information related to objects from outside.

(16) The driving support system as described in any one of (9) to (14) further includes a communication terminal device that includes a second position detection unit that detects position, in which the communication terminal device sends position information detected by the second position detection unit to the integration unit.

(17) In the driving support system as described in (16), the communication terminal device includes the sensor, and sends information related to objects detected by this sensor to the integration unit.

### Effects of the Invention

According to the present disclosure, it is possible to acquire information required for travel while suppressing an increase in cost.

### BRIEF DESCRIPTION OF THE DRAWINGS

FIG. 1 is a block diagram showing a configuration example of a driving support system of a first embodiment;

FIG. 2 is a sequence diagram showing a processing sequence of the driving support system of the first embodiment;

FIG. 3 is a block diagram showing a configuration example of the driving support system of a second embodiment;

FIG. 4 is a sequence diagram showing a processing sequence of a driving support system of the second embodiment;

FIG. 5 is a block diagram showing a configuration example of a driving support system of a third embodiment;

FIG. 6 is a sequence diagram showing a processing sequence of a driving support system of the third embodiment;

FIG. 7 is a schematic drawing of a driving support system according to embodiments;

FIG. 8 is a block diagram showing a configuration example of a driving support system of a fourth embodiment;

FIG. 9 is a sequence diagram showing a processing sequence of a driving support system of the fourth embodiment;

FIG. 10 is a block diagram showing a configuration example of a driving support system of a fifth embodiment;

FIG. 11 is a sequence diagram showing a processing sequence of a driving support system of the fifth embodiment;

FIG. 12 is a block diagram showing a configuration example of a driving support system of a sixth embodiment;

FIG. 13 is a block diagram showing a configuration example of a subject vehicle according to the sixth embodiment;

FIG. 14 is a block diagram showing a configuration example of a driving support system of a seventh embodiment;

FIG. 15 is a sequence diagram showing a processing sequence of a driving support system of the seventh embodiment;

FIG. 16 is a block diagram showing a configuration example of a communication terminal device of an eighth embodiment; and

FIG. 17 is a schematic diagram of a driving support system according to an embodiment.

### PREFERRED MODE FOR CARRYING OUT THE INVENTION

Next, various embodiments will be explained.

### First Embodiment

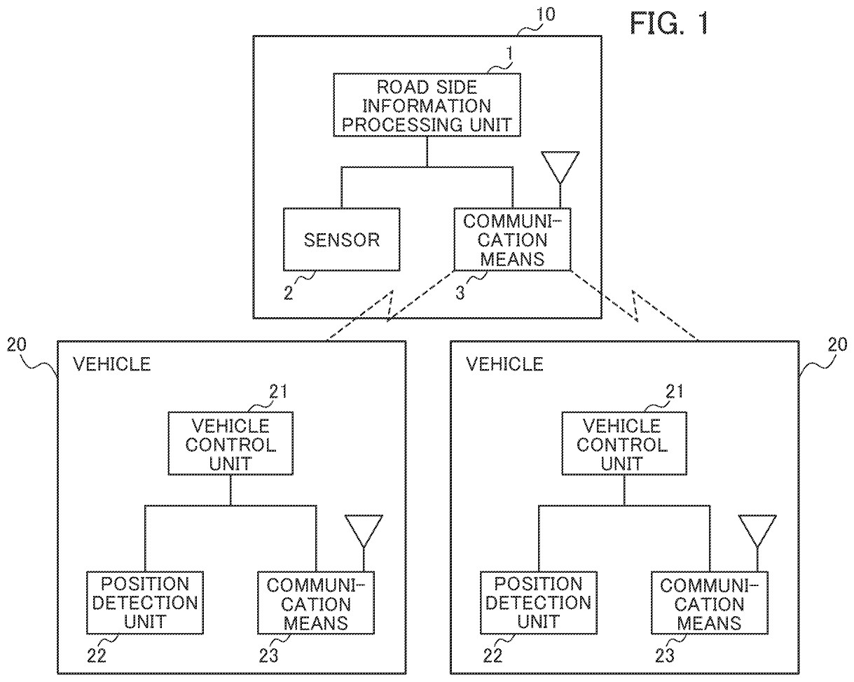

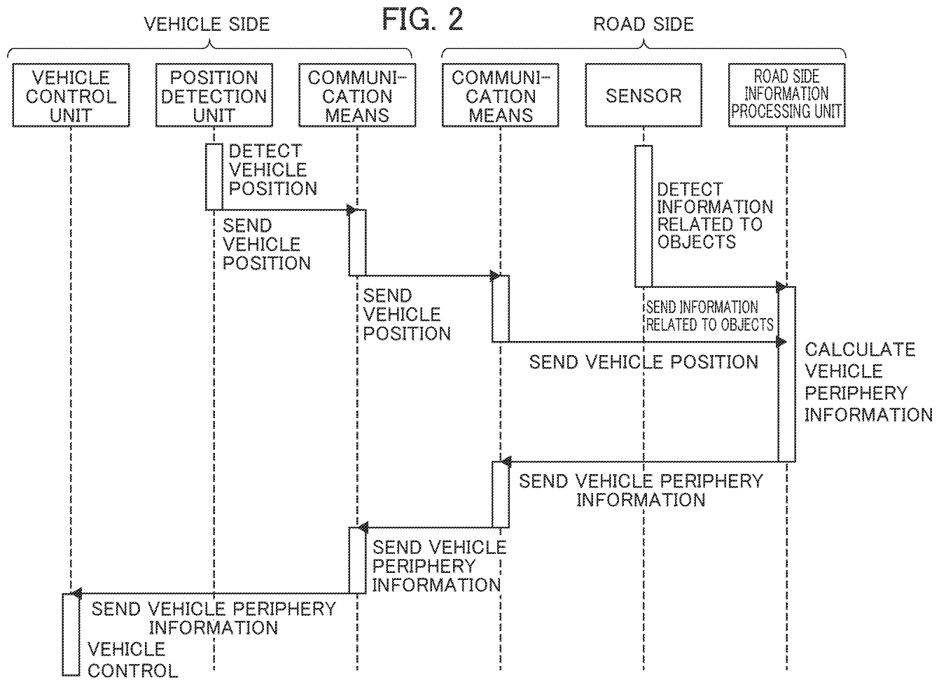

A first embodiment will be explained using FIGS. 1 and 2. FIG. 1 is a block diagram showing a configuration example of a driving support system according to the first embodiment. The driving support system is a system that uses information related to objects acquired by a sensor arranged outside of a subject vehicle, and position information of the subject vehicle to calculate information related objects in the vicinity of the subject vehicle so as to provide an autonomous driving control unit of the subject vehicle or a driver a warning, position information or information related to objects.

The driving support system includes: a road side information processing unit 1 arranged on the road side; a vehicle control unit 21 arranged at a subject vehicle, and a first position detection unit which is arranged on a side of the subject vehicle or on the road side, and which detects the position of the subject vehicle. The road side information processing unit 1 or the vehicle control unit 21 calculates the vehicle periphery information related to objects in the vicinity of the subject vehicle, using information related to the objects acquired by a sensor 2, and information of the subject vehicle detected by the first position detection unit. The road side information processing unit 1 sends, to the subject vehicle, at least one of the information related to objects and the vehicle periphery information. It should be noted that, although the sensor is explained as being one, two or more placed at the road side hereinafter, it is not to be limited to this configuration. In addition, the first position detection unit is explained as being arranged in the vehicle as the position detection unit 22; however, it is not limited to this configuration. In addition, “subject vehicle” refers to the vehicle to which at least one of information related to objects and vehicle periphery information is sent from the road side. In addition, the vehicle to which information is not sent from the road side is simply called “vehicle”.

The specific configuration will be explained hereinafter. Road side 10 is equipped with the roadside information processing unit 1 for processing information, one, two or more sensors 2 and a communication means 3 which performs wireless communication with a plurality of vehicles. The vehicle side is equipped with a vehicle control unit that controls the vehicle 20, the first position detection unit that detects the position of the vehicle and a communication means for communicating with the road side. It should be noted that, although FIG. 1 shows one sensor 2, it is not limited to this configuration, and two or more sensors 2 may be configured.

As one example, FIG. 2 shows the series of sequences of the present embodiment. First, the position detection unit on the vehicle side detects the position of the vehicle, and using the communication means, wirelessly communicates to the road side. Next, the vehicle periphery information is calculated in the road side information processing unit using the position of the vehicle received at the road side, and the information related to objects detected by one, two or more sensors on the road side. The calculated vehicle periphery information is wirelessly communicated from the road side to the vehicle side using the communication means. Using the vehicle periphery information received on the vehicle side, the vehicle control unit performs control of the vehicle.

The sensor is equipment which acquires information related to objects (information such as position, speed, angle of the objects), and is a millimeter-wave radar, laser radar, ultrasonic radar, camera or the like, for example. As the camera, it is possible to use any of a monocular camera and stereo camera.

The position detection unit 22 is arranged on the vehicle side, and detects the position of the subject vehicle using a positioning system which measures the position using signals from satellites. For example, the position detect unit 22 is a GPS receiver.

For wireless communication, for example, communication is performed following a predetermined communication protocol based on IEEE802.11p. As the frequency used in wireless communication, a frequency of the band 5.9 GHz, and 700 MHz can be exemplified.

In addition, the road side information processing unit 1 or vehicle control unit 21 calculates the vehicle periphery information by performing coordinate conversion on the information related to objects acquired from the sensor 2 relative to the position of the subject vehicle. Hereinafter, a configuration which calculates the vehicle periphery information by the road side information processing unit 1 will be specifically explained. The road side information processing unit 1 converts the information related to objects detected by the sensor 2 into Cartesian coordinates, and synthesizes information related to objects detected by another sensor on Cartesian coordinates.

In addition, the road side information processing unit 1 or vehicle control unit 21 may be configured to create a space model from the information related to objects acquired from the sensor 2, and calculates the vehicle periphery information from the space model and the position of the subject vehicle. Hereinafter, a configuration in which the vehicle periphery information is calculated by the road side information processing unit 1 will be specifically explained. The road side information processing unit 1 performs three-dimensional modeling upon synthesizing the information related to objects. Each piece of information related to objects to be synthesized, for example, is information including distances between each sensor and another vehicle, pedestrians, obstacles, buildings, etc., in the vicinity with the center of the coordinates being at the sensor, for example.

Next, using the information related to objects synthesized and the vehicle position, coordinate conversion is performed so that they become information related to objects centered on the vehicle position, thereby obtaining vehicle periphery information. The vehicle periphery information, for example, is information including the distance between its own vehicle and another vehicle, pedestrians, obstacles, buildings, etc., in the vicinity, with the center of the coordinates being at its own vehicle.

Regarding the processing of the road side information processing unit, a part or the entirety of the processing may be performed by the vehicle control unit. In this case, the road side information processing unit wirelessly transmits the information related to objects to the vehicle side without additionally processing the information related to objects, or by performing data compression.

### Second Embodiment

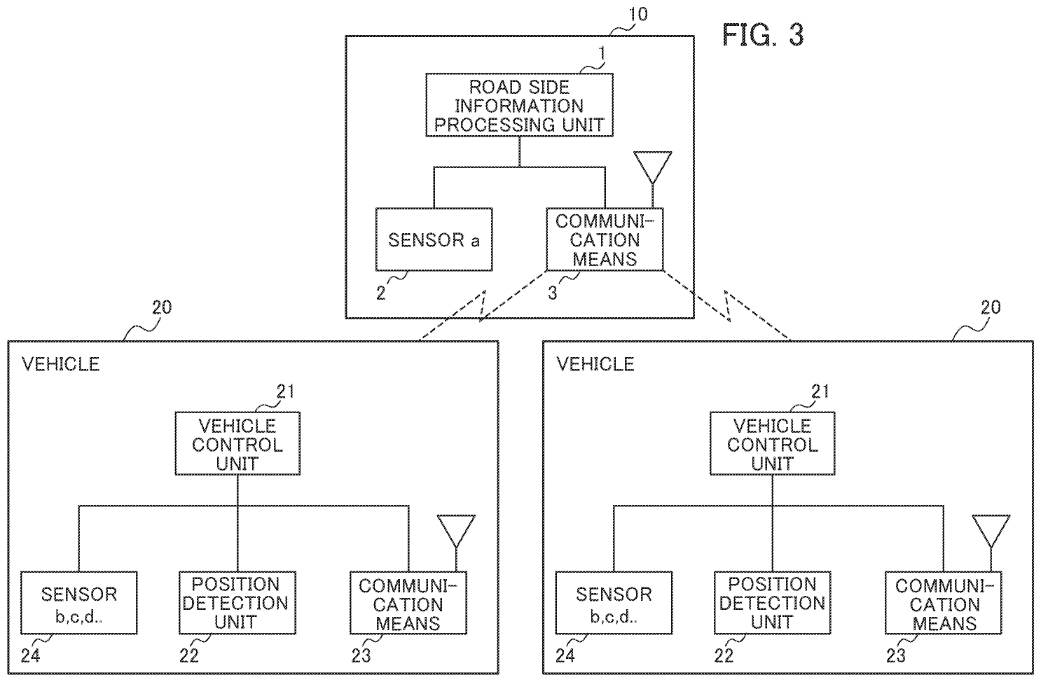

A second embodiment will be explained using FIG. 3. Relative to the first embodiment, in the second embodiment, a sensor is also provided to the vehicle side. The driving support system includes a road side communication unit arranged at the road side (hereinafter explained as communication means 3) and a vehicle communication unit arranged at the subject vehicle side (hereinafter, explained as communication means 23). The communication means 3 transmits the vehicle periphery information to the communication means 23.

More specifically, the sensor 24 mounted to the vehicle side, for example, is a millimeter-wave radar, ultrasonic radar and/or camera, and the sensor mounted to the road side is a laser radar, for example. Although FIG. 3 illustrates a case where one sensor 2 is configured as a single sensor a, the present invention is not limited to this configuration, and the sensor 2 may be configured by two or more sensors. In addition, although FIG. 3 shows a case where the sensor 24 is configured as three sensors b, c, d, the present invention is not limited to this configuration, and the sensor 24 may be configured by any number of sensors so long as it is configured as one or more sensors.

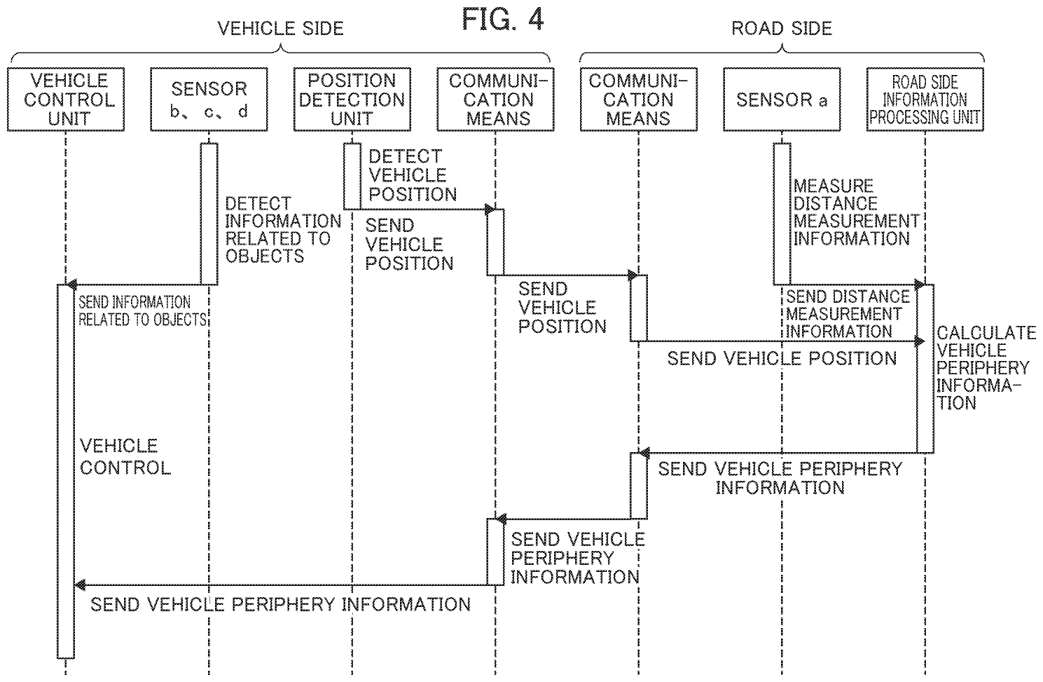

As one example, FIG. 4 shows the series of sequences of the present embodiment. First, the position detection unit on the vehicle side detects the position of the vehicle, and wirelessly communicates to the road side using the communication means. Next, using the position of the vehicle received on the road side and the information related to objects detected by one, two or more sensors on the road side, the road side information processing unit calculates vehicle periphery information. The calculated vehicle periphery information is wirelessly communicated to the vehicle side from the road side using the communication means. The vehicle control unit performs control of the vehicle using the vehicle periphery information received on the vehicle side and information related to objects detected by a sensor on the vehicle side. The sensor, wireless communication and road side information processing unit are similar to those of the first embodiment.

### Third Embodiment

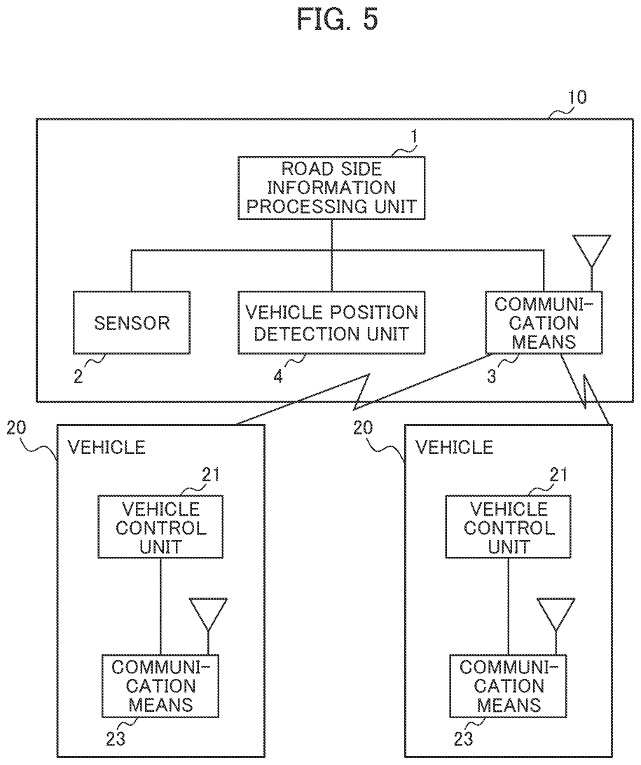

A third embodiment will be explained using FIG. 5. Relative to the first embodiment, in the third embodiment, there is no position detection unit on the vehicle side, and a vehicle position detection unit is provided on the road side.

The driving support system includes: the road side communication unit arranged at the roadside (hereinafter explained as communication means 3); and the vehicle communication unit arranged at the subject vehicle side (hereinafter explained as communication means 23). The communication means 3 sends information related to objects acquired by the sensor 2 to the communication means 23. The vehicle control unit 21 calculates the vehicle periphery information, using the information related to objects received by the communication means 23, and the position of the subject vehicle detected by the first position detection unit (hereinafter explained as vehicle position detection unit 4).

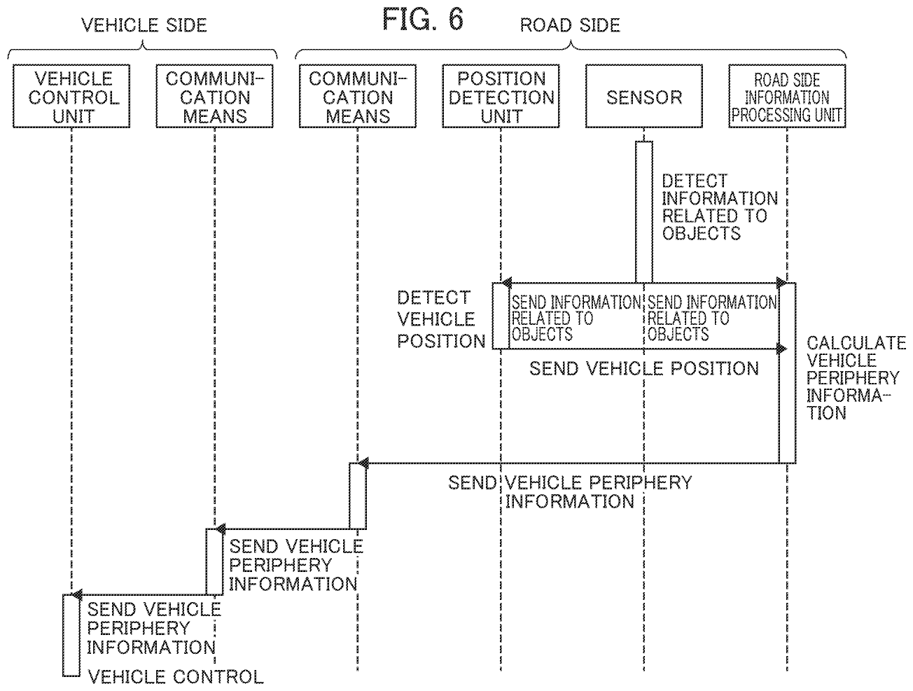

The present embodiment assumes a place where GPS does not function such as an indoor parking garage. As an example, FIG. 6 shows the series of sequences of the present embodiment. First, the vehicle position detection unit 4 on the road side detects the vehicle position using information related to objects detected by one, two or more sensors on the road side, and then sends it to the road side information processing unit 1. The road side information processing unit 1 calculates the vehicle periphery information using the information related to objects detected by the sensor 2 and the vehicle position. The calculated vehicle periphery information is wirelessly communicated from the road side to the vehicle side, using the communication means. The vehicle control unit performs control of the vehicle using the vehicle periphery information received on the vehicle side. The sensor, wireless communication and processing by the road side information processing unit are similar to those of the first embodiment.

The vehicle position detection unit 4 estimates the position of the subject vehicle using the information related to objects acquired by the sensor 2. For example, the vehicle position detection unit 4 specifies the position of the subject vehicle, based on the information related to objects acquired by the sensor 2. The position of the subject vehicle specified herein is a relative position relative to the sensor 2 as the reference (origin). The vehicle position detection unit 4 estimates the absolute position (information of latitude and longitude) of the subject vehicle, using the position information of itself set in advance (information of latitude and longitude).

Here, the position of the subject vehicle is absolute position or relative position. Absolute position refers to a position of the subject vehicle represented by latitude and longitude. Relative position refers to a position of the subject vehicle represented relative to a position of the road side or another vehicle as the reference.

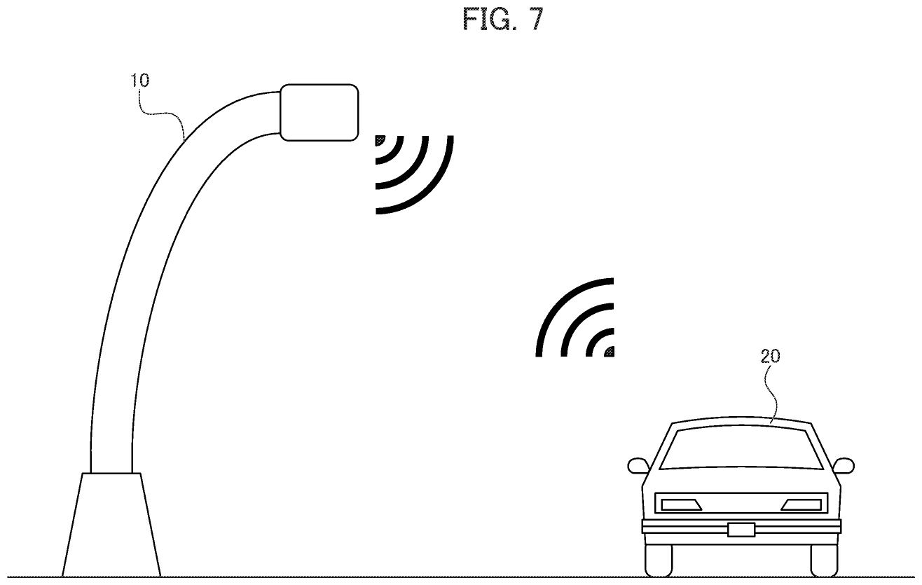

FIG. 7 is a schematic diagram of the driving support system according to the first to third embodiments. It shows that the road side 10 and the subject vehicle 20 communicate with each other.

### Fourth Embodiment

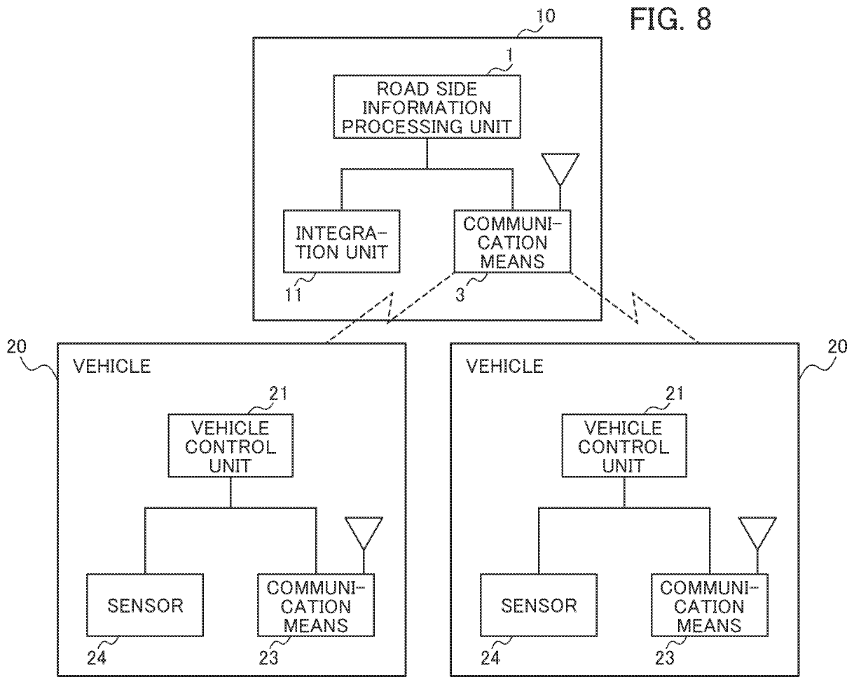

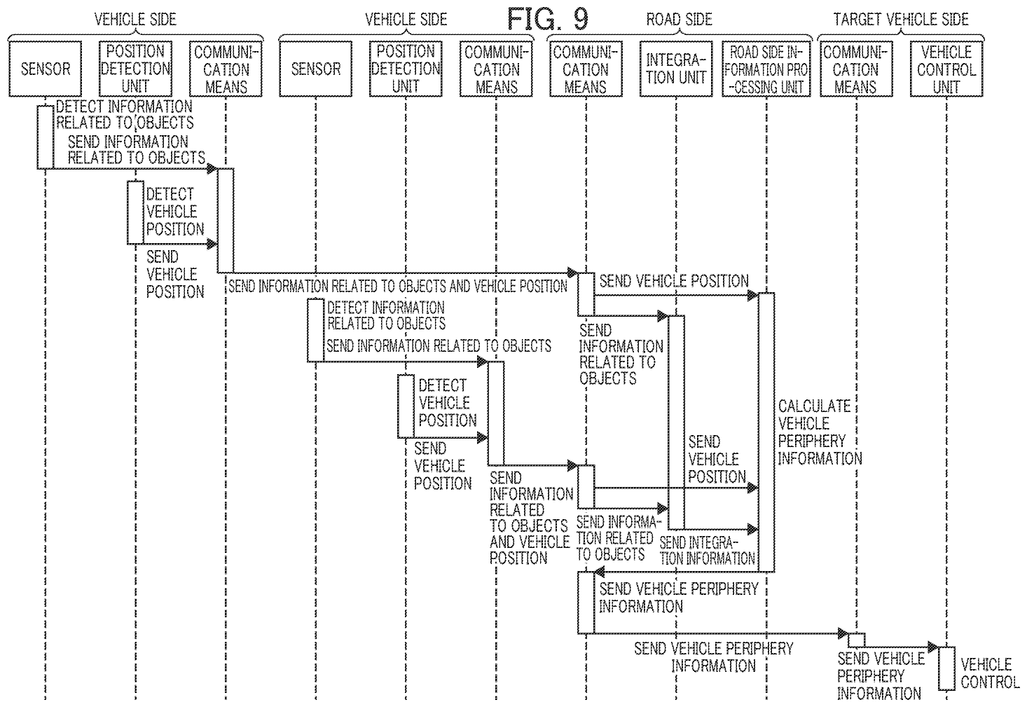

A fourth embodiment will be explained using FIGS. 8 and 9. FIG. 8 is a block diagram showing a configuration example of a driving support system according to the fourth embodiment.

The driving support system further has a sensor 24 arranged at the vehicle. In this configuration, an integration unit 11 that integrates information related to objects acquired by a plurality of sensors 24 is arranged at the road side, and the vehicle periphery information is calculated using the information related to objects that has been integrated by the integration unit 11 and the position of the subject vehicle detected by the first position detection unit.

Although FIG. 8 shows two vehicles, the present invention is not limited to this configuration, and there may be three or more vehicles.

In addition, a configuration can also be considered in which the subject vehicle is not included among vehicles equipped with the sensor 2 and sending information related to objects to the road side. In the case of this configuration, on the road side, the information related to objects acquired by the sensor 2 of other vehicles is integrated by the integration unit 11, and sends the integrated information to the subject vehicle. The subject vehicle calculates the vehicle periphery information using the information related to objects, which was sent from the road side, and the position of this vehicle, and performs control of the vehicle by the vehicle control unit using the calculated vehicle periphery information.

Here, the road side may calculate the vehicle periphery information using the information related to objects integrated by the integration unit 11, and the position of the subject vehicle, and may send the calculated vehicle periphery information to the subject vehicle.

Further, the process of “integrating information related to objects acquired by a plurality of sensors” can include integrating information related to the position at which each object exists, speed, type, etc., of each object acquired form the plurality of sensors into one set of map information. In addition, it can include, for a single object, integrating information related to the position at which the object exists, speed, type, etc., of the object obtained from the plurality of sensors, and establishing association among them.

As an example, FIG. 9 shows the series of sequences of the present embodiment. Although each vehicle providing information related to objects (hereinafter simply called “vehicle”) is explained as being equipped with a sensor and a position detection unit, the present invention is not limited to this configuration. In addition, although the subject vehicle is explained as including a sensor and vehicle position detection unit, the present invention is not limited to this configuration.

Each vehicle detects the position of its own vehicle by the position detection unit, and detects the information related to objects by the sensor. Each vehicle sends the vehicle position and the information related to objects to the road side. The road side integrates the information related to objects sent from the vehicles and generates integrated information. In addition, the road side calculates the position of the subject vehicle, based on the vehicle positions sent from the vehicles. The road side calculates the vehicle periphery information, based on the integrated information and the position of the subject vehicle. The road side sends the calculated vehicle periphery information to the subject vehicle. The subject vehicle performs control of the vehicle based on the vehicle periphery information sent from the road side.

Here, the subject vehicle itself may include a vehicle position detection unit that detects the position of its own vehicle. In the case of such a configuration, the road side may not need to collect information of the vehicle positions from vehicles other than the subject vehicle in order to calculate the position of the subject vehicle.

This way, even when the subject vehicle does not have a sensor in itself, the subject vehicle can perform control of the vehicle based on the vehicle periphery information sent from the road side, and therefore, the subject vehicle can acquire information required for traveling, while suppressing an increase in cost.

### Fifth Embodiment

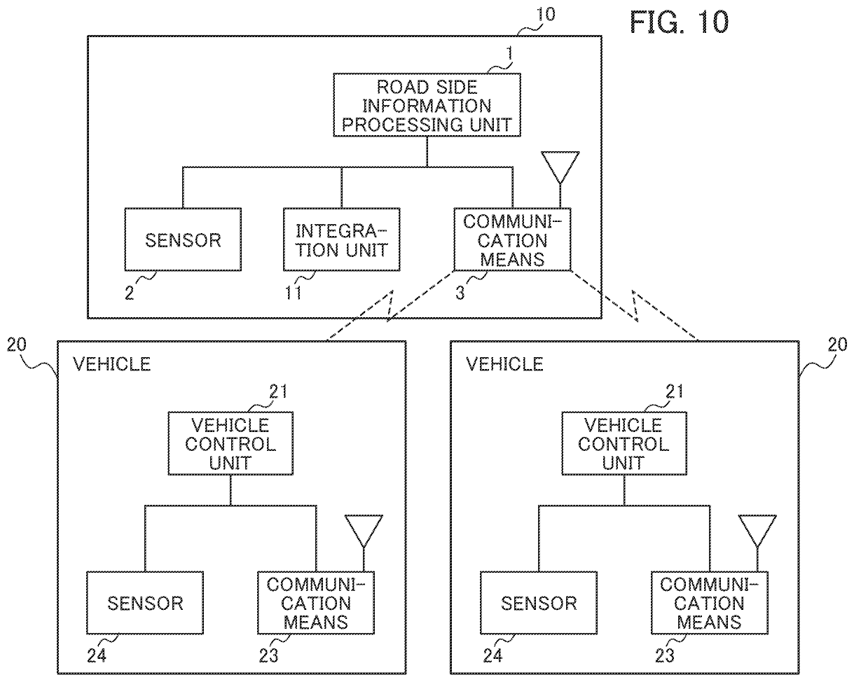

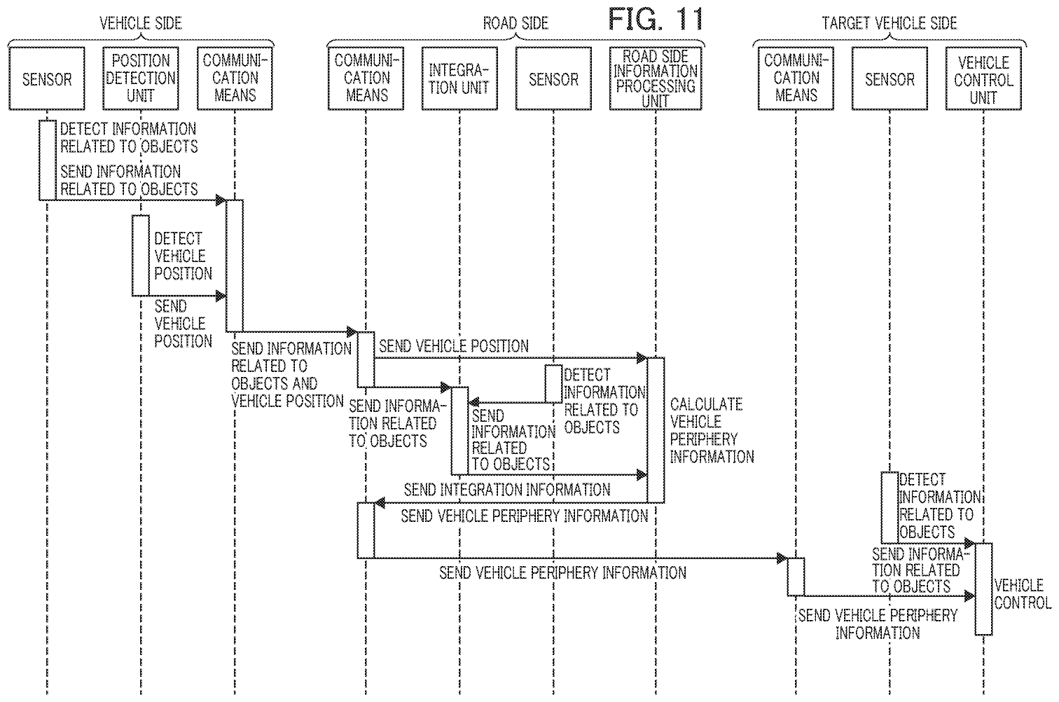

A fifth embodiment will be explained using FIGS. 10 and 11. FIG. 10 is a block diagram showing a configuration example of a driving support system according to the fifth embodiment.

The driving support system includes at least one vehicle and a sensor arranged at the road side. An integration unit that integrates information related to objects acquired from the plurality of sensors is arranged at the road side. The vehicle periphery information is calculated using the information related to objects integrated by the integration unit and the position of the subject vehicle detected by the first position detection unit. In addition, the information related to objects acquired by the sensor arranged at the roadside differs from information related to objects acquired by a sensor arranged in at least one vehicle. Although the fifth embodiment will be explained as a configuration in which the subject vehicle is included among the vehicles, the present invention is not limited to this configuration.

For example, the sensor of the vehicle detects the information related to objects at a short to mid range (for example, distance of range of 20 m from the sensor of vehicle). For example, the sensor of the road side detects information related to objects at a far distance (for example, distance of range of 100 m from the sensor of road side). By the integration unit integrating these pieces of information, it is possible to calculate the vehicle periphery information in a wide range from short distance to long distance in the subject vehicle.

In addition, the sensor at the road side is arranged at a position higher than the sensor in the vehicle. By integrating the information related to objects detected by the sensor at the road side and the information related to objects detected by the sensor in the vehicle, information about an area that is a dead spot for the sensor in the vehicle and cannot be detected by the sensor in the vehicle can be supplemented by information related to objects detected by the sensor at road side, for example.

In addition, the sensor at the road side may have a higher distance resolution and a higher angular resolution with respect to an object, as compared to the sensor at the vehicle. In this a configuration, at locations where the subject vehicle cannot communicate with the road side, information related to objects detected by its own sensor is used and at locations where communication with the road side is possible, information related to objects having a higher distance resolution and angular resolution detected by sensors on the road side can also be used.

Next, as one example, FIG. 11 shows the series of sequences of the present embodiment. Although the vehicle that provides information related to objects (hereinafter simply called “vehicle”), as described below, includes a sensor and a position detection unit, the present invention is not limited to this configuration. Further, although the subject vehicle, as described below, includes a sensor, the present invention is not limited to this configuration.

The vehicle detects the position of its own vehicle by the position detection unit, and detects information related to objects by a sensor. The vehicle sends the vehicle position and the information related to objects to the road side. The road side integrates information related to objects detected by the sensor of itself, and information related to objects which was sent from the vehicle, thereby generating integrated information. In addition, the road side calculates the position of the subject vehicle, based on the vehicle position sent from the vehicle. The road side calculates the vehicle periphery information, based on the integrated information and the position of the subject vehicle. The road side sends the calculated vehicle periphery information to the subject vehicle. The subject vehicle performs control of the vehicle using the information related to objects detected by its own sensor, and the vehicle periphery information sent from the road side.

Here, the subject vehicle may include a vehicle position detection unit that detects the position of its own vehicle. In this configuration, the road side may not need to collect information of the vehicle position from vehicles other than the subject vehicle in order to calculate the position of the subject vehicle.

This way, the subject vehicle can perform control of the vehicle using vehicle periphery information sent from the road side without expensive sensors, and therefore, the subject vehicle can acquire the information required for traveling while suppressing an increase in cost.

### Sixth Embodiment

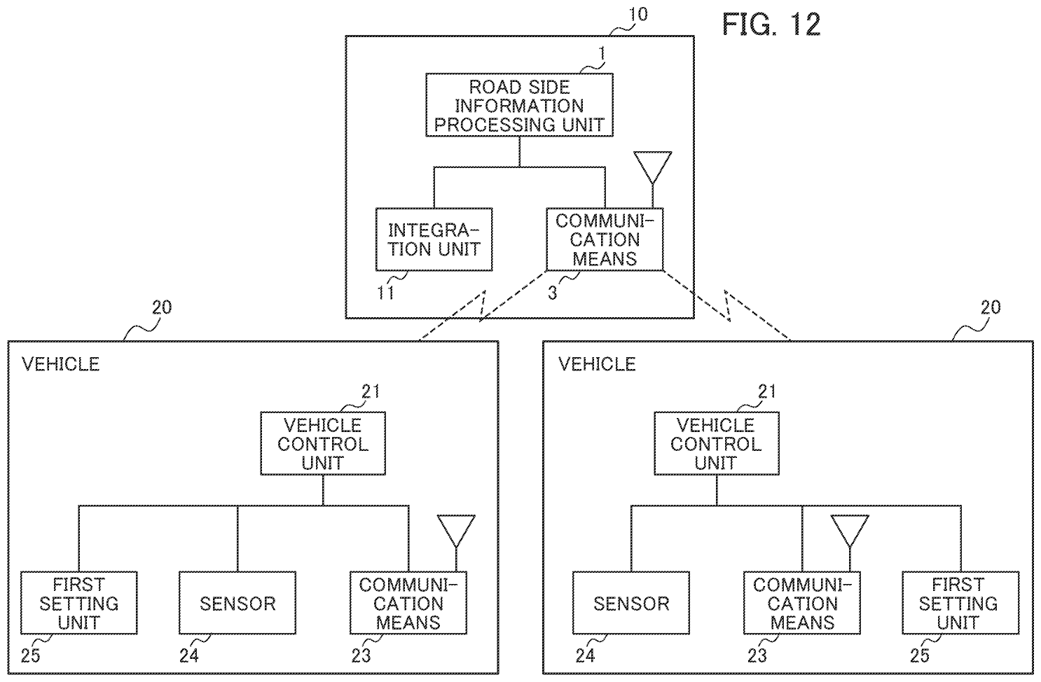

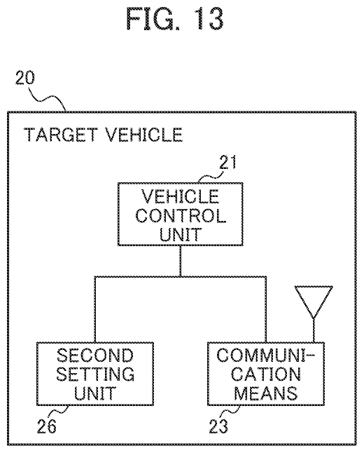

A sixth embodiment will be explained using FIGS. 12 and 13. FIG. 12 is a block diagram showing a configuration example of a driving support system according to the sixth embodiment. FIG. 13 is a block diagram showing a configuration example of a subject vehicle according to the sixth embodiment.

In this driving support system, the vehicle to which the sensor is arranged includes a first setting unit 25 that specifies whether or not to provide information related to objects acquired by its own sensor 24 to the integration unit 11. Although FIG. 12 shows an example in which there are two such vehicles, the present invention is not limited to this configuration.

When the first setting unit 25 is in the ON setting (a setting permitting the provision of information related to objects) due to a user operation, the information related to objects detected by the sensor 24 is sent to the road side via the communication means 23. The road side sends the information related to objects received by the communication means 3 to the integration unit 11. The integration unit 11 integrates the information related to a plurality of objects, and generates integrated information. When the first setting unit 25 is in the OFF setting (a setting not permitting provision of information related to objects), the information related to objects detected by the sensor 24 is not sent to the road side.

In addition, the subject vehicle may include a second setting unit 26 that specifies whether or not to receive information related to objects from outside.

When the second setting unit 26 is in the ON setting (a setting accepting the information related to objects) due to a user operation, the vehicle control unit 21 sends a request for acquiring information related to objects, for example, to the road side. The road side sends information related to objects (which may be vehicle periphery information) to the subject vehicle, in response to the request sent from the subject vehicle. When the second setting unit 26 is in the OFF setting (a setting not to accept information related to objects), the request for acquiring information related to objects is not sent to the road side.

Here, the system may be configured such that consideration (monies, points for various services, etc.) is paid to users that have provided the information related to objects as an information providing fee. Further, the system may be configured such that consideration is collected from the users receiving the information related to objects as an information providing fee. According to these configurations, it is possible to construct a new business that trades information related to objects.

### Seventh Embodiment

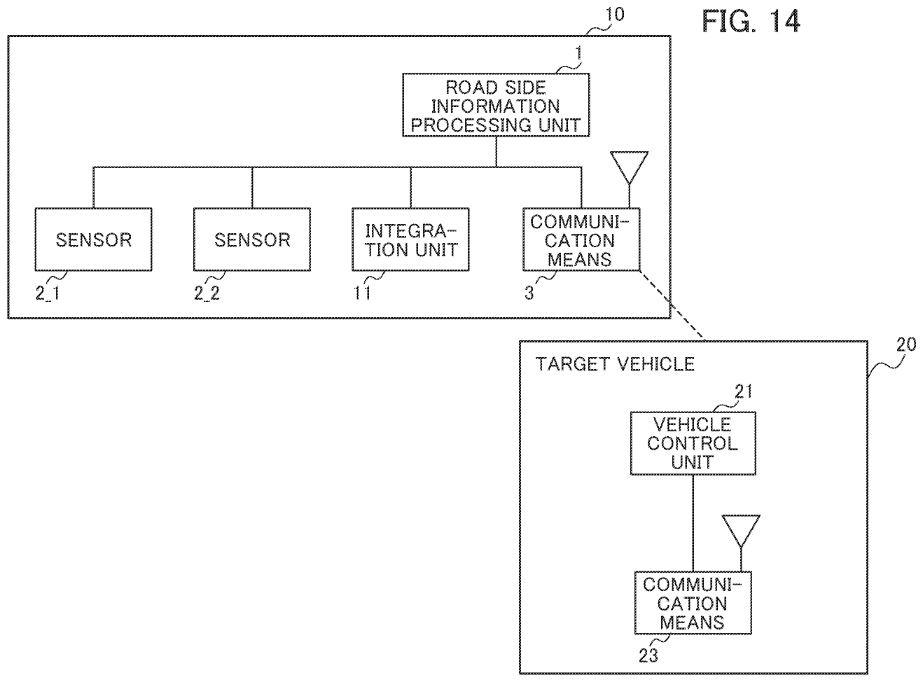

A seventh embodiment will be explained using FIG. 14. FIG. 14 is a block diagram showing a configuration example of a driving support system according to the seventh embodiment.

In this driving support system, at least two sensors and an integration unit that integrates information related to objects acquired from the sensors are arranged at the road side. The vehicle periphery information is calculated employing the information related to objects integrated by the integration unit, and the position of the subject vehicle detected by the first position detection unit.

In the example shown in FIG. 14, although the two of the sensor 2_1 and sensor 2_2 are arranged at the road side, three or more may be arranged. For example, the sensor 2_1 and sensor 2_2 may be arranged by varying the angle so that the directions in which detecting information related to objects differ in the horizontal direction, and may be arranged by changing the height so that the heights at which detecting information related to objects differ in the vertical direction.

The integration unit 11 integrates information related to objects sent from the sensors 2_1 and 2_2. The communication means 3 sends the integrated information to the subject vehicle. The subject vehicle uses the information related to objects sent from the road side to calculate the vehicle periphery information, and using the calculated vehicle peripheral information, the vehicle control unit performs control of the vehicle.

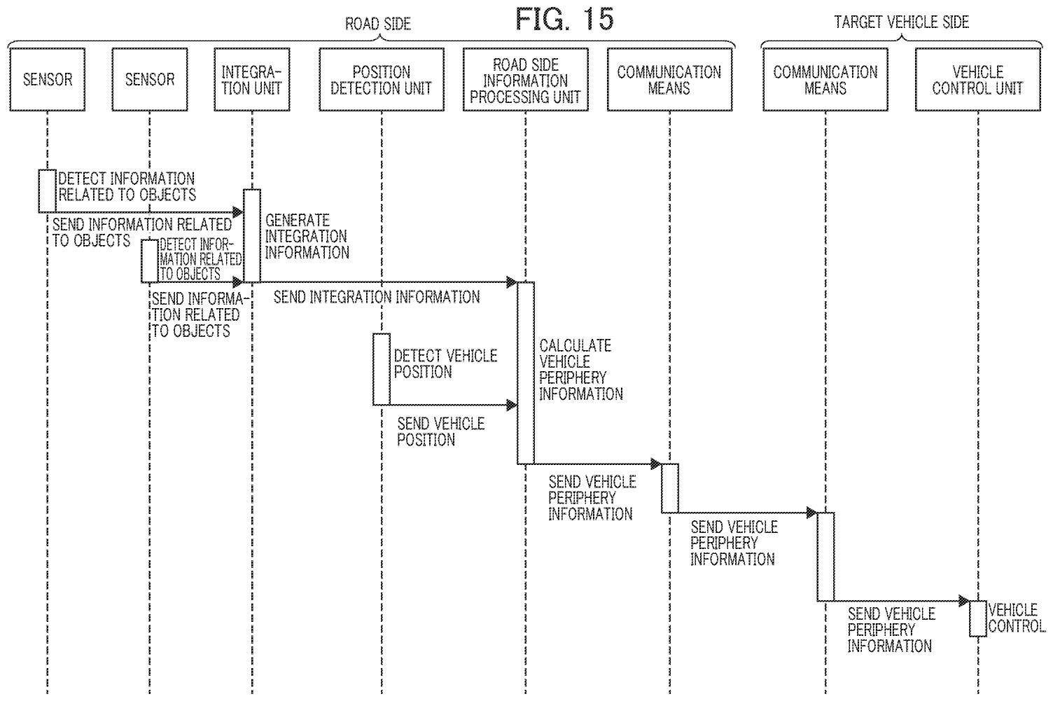

As an example, FIG. 15 shows the series of sequence of the present embodiment. Although the subject vehicle does not include sensors and the vehicle position detection unit in this example, the present invention is not limited to this configuration.

Each sensor detects information related to objects, and sends the detected information related to objects to the integration unit. The integration unit integrates the information related to objects to generate integrated information, and sends the generated integrated information to the road side information processing unit. In addition, a position detection unit detects the position of the subject vehicle, and sends the detected vehicle position to the road side information processing unit. The road side information processing unit calculates the vehicle periphery information based on the integrated information and the position of the subject vehicle. The communication means at the road side sends the calculated vehicle periphery information to the subject vehicle. The subject vehicle performs control of the vehicle according to the vehicle periphery information sent from the road side.

This way, the subject vehicle can perform control of the vehicle according to the vehicle periphery information sent from the road side without including a sensor in itself, and therefore, the subject vehicle can acquire the information required for travel, while suppressing an increase in cost.

### Eighth Embodiment

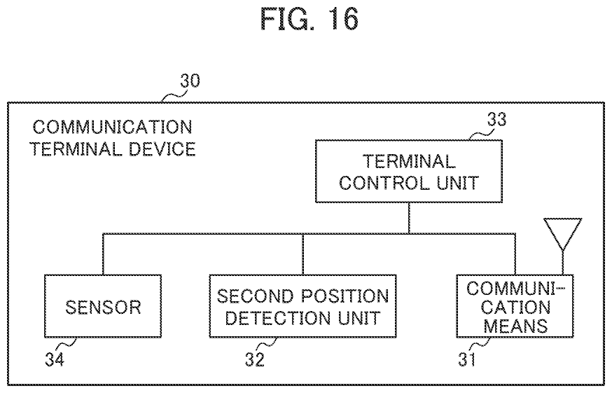

An eighth embodiment will be explained using FIG. 16. FIG. 16 is a block diagram showing a configuration example of a communication terminal device according to the eighth embodiment.

The driving support system may include a communication terminal device 30. The communication terminal device 30 includes a communication means 31 that performs communication with the outside, a second position detection unit 32 that detects position, and a terminal control unit 33 that performs control of the overall terminal. The communication terminal device 30 sends position information detected by the second position detection unit 32 to an integration unit of the road side via the communication means 31. In addition, the communication terminal device 30 may include a sensor 34 that detects information related to objects. The communication terminal device 30 sends information related to objects detected by the sensor 34 to the integration unit of the road side via the communication means 31.

The communication terminal device is capable of mobile communication, and is a portable telephone, smartphone, tablet or the like, for example.

This way, the driving support system can perform driving support on the subject vehicle 20, employing position information and information related to objects sent from the communication terminal device 30.

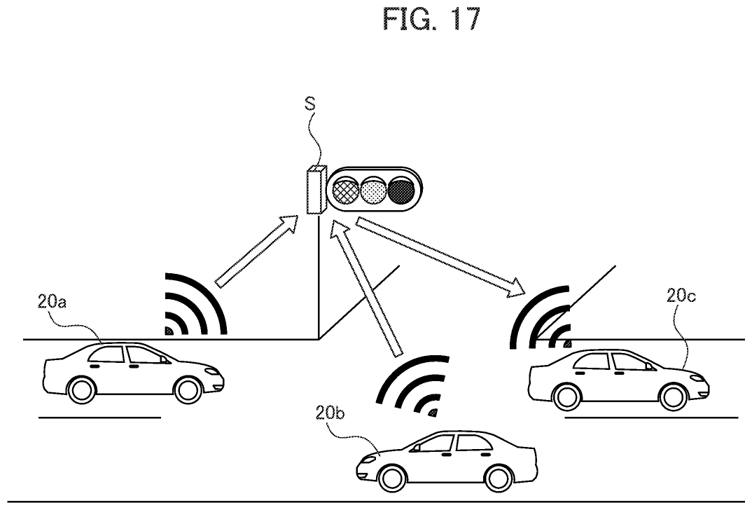

FIG. 17 is a schematic diagram of a driving support system. FIG. 17 shows a traffic light S as an example of the “road side.” The vehicle 20a and vehicle 20b send information related to the vehicle to the traffic light S, which is at the road side. The traffic light S integrates the information related to vehicles sent from the vehicle 20a and vehicle 20b, and sends the integrated information to the vehicle 20c, which is the subject of control.

In addition, the sensor arranged at the road side may be configured to change the region for acquiring the information related to vehicles based on the position information of the subject vehicle, so that the region includes this position information and the vicinity thereof. For example, if the sensor is a camera, the orientation of the camera can be changed. In addition, if the sensor is a radar, for example, the irradiating direction of radar can be changed. According to this configuration, it is possible to acquire the optimal information related to vehicles in accordance with the position of the subject vehicle.

Here, the information integration unit may be configured to integrate information related to vehicles acquired from a plurality of sensors by way of processing using machine learning and artificial intelligence (AI), and sends the integrated information to the subject vehicle. According to this configuration, the subject vehicle can perform driving support using prediction information obtained from processing by machine learning or the like.

### EXPLANATION OF REFERENCE NUMERALS

1 road side information processing unit
2, 2_1, 2-1, 24, 34 sensor
3, 23, 31 communication means
10 road side
11 integration unit
20 vehicle, subject vehicle
21 vehicle control unit
22 position detection unit
25 first setting unit
26 second setting unit
30 communication terminal device
32 second position detection unit
33 terminal control unit

1: A driving support system that uses information related to objects acquired by a sensor disposed external to a subject vehicle and position information of the subject vehicle to calculate information related to objects in a periphery of the subject vehicle, and provides a warning, position information or information related to objects to an autonomous driving control unit or a driver of the subject vehicle, the driving support system comprising:
a road side information processing unit disposed at a road side;
a vehicle control unit disposed on a side of the subject vehicle; and
a first position detection unit that is disposed on the side of the subject vehicle or the road side and that detects a position of the subject vehicle,
wherein the road side information processing unit or the vehicle control unit calculates vehicle periphery information related to objects in the periphery of the subject vehicle, using the information related to objects acquired from the sensor and the position of the subject vehicle detected by the first position detection unit, and
wherein the road side information processing unit sends at least one of the information related to objects and the vehicle periphery information to the subject vehicle.

2: The driving support system according to claim 1, further comprising:
a road side communication unit disposed at the road side; and
a vehicle communication unit disposed on the side of the subject vehicle,
wherein the road side communication unit sends the vehicle periphery information to the vehicle communication unit.

3: The driving support system according to claim 1, further comprising:
a road side communication unit disposed at the road side; and
a vehicle communication unit disposed on the side of the subject vehicle,
wherein the road side communication unit sends information related to objects acquired from the sensor to the vehicle communication unit, and
wherein the vehicle control unit calculates the vehicle periphery information, using the information related to objects received from the vehicle communication unit and the position of the subject vehicle detected by the first position detection unit.

4: The driving support system according to claim 1, wherein the road side information processing unit or the vehicle control unit calculates the vehicle periphery information by performing coordinate conversion on the information related to objects acquired from the sensor relative to the position of the subject vehicle.

5: The driving support system according to claim 1, wherein the road side information processing unit or the vehicle control unit creates a space model from the information related to objects acquired from the sensor, and calculates the vehicle periphery information from the space model and the position of the subject vehicle.

6: The driving support system according to claim 1, wherein the first position detection unit is disposed on the side of the subject vehicle, and detects the position of the subject vehicle using a positioning system that measures positions using a signal from a satellite.

7: The driving support system according to claim 1, wherein the first position detection unit estimates the position of the subject vehicle using the information related to objects acquired from the sensor.

8: The driving support system according to claim 1, wherein the position of the subject vehicle is an absolute position or a relative position.

9: The driving support system according to claim 1,
wherein said sensor is provided in a plurality and installed respectively in a plurality of vehicles other than the subject vehicle,
wherein an integration unit that integrates information related to objects acquired from the plurality of said sensors is disposed on the road side, and
wherein the vehicle periphery information is calculated using the information related to objects integrated by the integration unit and the position of the subject vehicle detected by the first position detection unit.

10: The driving support system according to claim 1, further comprising the sensor disposed in at least one vehicle and on the road side,
wherein an integration unit that integrates information related to objects acquired from a plurality of the sensors is disposed at the road side, and
wherein the vehicle periphery information is calculated using information related to objects integrated by the integration unit, and the position of the subject vehicle detected by the first position detection unit.

11: The driving support system according to claim 10, wherein the information related to objects acquired from the sensor disposed at the road side differs from the information related to objects acquired from the sensor disposed in the at least one vehicle.

12: The driving support system claim 9,
wherein said sensor is provided in a plurality and installed respectively in a plurality of vehicles other than the subject vehicle,
wherein the subject vehicle further includes another sensor,
wherein an integration unit that integrates information related to objects acquired from the plurality of said sensors in the plurality of vehicles and information related to objected acquired from said another sensor in the subject vehicle is disposed on the road side, and
wherein the vehicle periphery information is calculated using the information related to objects integrated by the integration unit, and the position of the subject vehicle detected by the first position detection unit.

13: The driving support system according to claim 9, wherein each of the vehicles in which the sensor is disposed includes a first setting unit that specifies whether or not to provide information related to objects acquired from the sensor to the integration unit.

14: The driving support system according to claim 1, wherein at least two of the sensors, and an integration unit that integrates information related to objects acquired from the sensors are disposed at the road side, and
wherein the vehicle periphery information is calculated using the information related to objects integrated by the integration unit and the position of the subject vehicle detected by the first position detection unit.

15: The driving support system according to claim 1, wherein the subject vehicle includes a second setting unit which specifies whether or not to receive information related to objects from outside.

16: The driving support system according to claim 9, further comprising a communication terminal device that includes a second position detection unit that detects position,
wherein the communication terminal device sends position information detected by the second position detection unit to the integration unit.

17: The driving support system according to claim 16, wherein the communication terminal device includes the sensor, and sends information related to objects detected by this sensor to the integration unit.
